(19) United States
(12) Patent Application Publication
(10) Pub. No.: US 2018/0368085 A1
(43) Pub. Date: Dec. 20, 2018

(54) WIRELESS SYNCHRONIZATION SYSTEM AND WIRELESS DEVICE

(71) Applicant: Renesas Electronics Corporation, Tokyo (JP)

(72) Inventors: Taku FUJIWARA, Tokyo (JP); Yuichi MARUYAMA, Tokyo (JP)

(21) Appl. No.: 15/960,804

(22) Filed: Apr. 24, 2018

(30) Foreign Application Priority Data
Jun. 20, 2017 (JP) 2017-120640

(51) Int. Cl. H04W 56/00; H04L 12/26

(52) U.S. Cl. CPC H04W 56/001; H04L 43/103; H04L 43/16

(57) ABSTRACT

A first device of a wireless synchronization system includes: a first sensor for measuring a physical quantity related to power consumed by wireless communication process of a first communication circuit; and a first control circuit outputting a first synchronization signal at a timing that the magnitude relation between the physical quantity measured by the first sensor with respect to one of transmitting process and receiving process in the wireless communication process and a predetermined threshold value changes. A second device includes a second control circuit outputting a second synchronization signal at a timing that the magnitude relation between the physical quantity measured by the second sensor with respect to the other one of the transmitting and receiving processes in the wireless communication process in a second communication circuit and a predetermined threshold value changes.

### CROSS-REFERENCE TO RELATED APPLICATIONS

The disclosure of Japanese Patent Application No. 2017-120640 filed on Jun. 20, 2017 including the specification, drawings and abstract is incorporated herein by reference in its entirety.

### BACKGROUND

The present disclosure relates to a synchronizing process and, more specifically, relates to a synchronizing process using wireless communication.

Various techniques of making operations of a plurality of devices synchronized have been proposed. For example, Japanese Unexamined Patent Application Publication No. 2012-244692 (patent literature 1) discloses “parallel running control apparatus for inverter generators enabling parallel running of a plurality of inverter generators outputting three-phase alternate current”. Moreover, a technique for synchronizing operations of a plurality of motors used for robot articulation or the like is proposed.

### SUMMARY

Generally, to make a plurality of devices synchronized with high precision, it is requested to couple the plurality of devices by wire. However, in the case of coupling the plurality of devices by wire, the system configuration including the plurality of devices becomes complicated. In some cases, a person who does not have exert knowledge cannot accurately couple a plurality of devices. Therefore, a technique of accurately coupling a plurality of devices and synchronizing them is in demand.

The present disclosure is achieved to solve the problems as described above and an object of the disclosure is to provide a technique of synchronizing a plurality of devices with high precision by using wireless communication.

The other objects and novel features will become apparent from the description of the specification and appended drawings.

A wireless synchronization system according to an embodiment has a first device and a second device. The first device includes: a first communication circuit for performing wireless communication with the second device; a first sensor for measuring a physical quantity related to power consumed by wireless communication process of the first communication circuit; a first control circuit outputting a first synchronization signal at a timing that the magnitude relation between the physical quantity measured by the first sensor with respect to one of transmitting process and receiving process in the wireless communication process and a predetermined threshold value changes; and a first equipment operating according to a first synchronization signal output by the first control circuit. The second device includes: a second communication circuit for performing wireless communication with the first device; a second sensor for measuring a physical quantity related to power consumed by wireless communication process of the second communication circuit; a second control circuit outputting a second synchronization signal at a timing that the magnitude relation between the physical quantity measured by the second sensor with respect to the other one of the transmitting process and the receiving process in the wireless communication process in the second communication circuit and a predetermined threshold value changes; and a second equipment operating according to the second synchronization signal output by the second control circuit.

By the wireless synchronization system according to the embodiment, a plurality of devices can be synchronized with high precision by using wireless communication.

### BRIEF DESCRIPTION OF THE DRAWINGS

FIG. 1 is a block diagram expressing the configuration of a wireless system according to a first embodiment.

FIG. 2 is a diagram for explaining processes of communication modules in a state where coupling is established.

FIGS. 3A and 3B are diagrams for explaining consumption current in communication circuits.

FIG. 4 is a sequence chart explaining wireless communication process of the wireless system according to the first embodiment.

FIG. 5 is a diagram for explaining a timing of outputting a synchronization signal by a wireless system according to a second embodiment.

FIG. 6 is a diagram for explaining a synchronization mode and a normal mode of a wireless system according to a third embodiment.

FIG. 7 is a diagram expressing an example of the data structure of a packet transmitted/received between communication modules.

FIG. 8 is a sequence chart explaining wireless communication process of the wireless system according to the third embodiment.

FIG. 9 is a block diagram expressing the configuration of a wireless system according to a fourth embodiment.

FIG. 10 is a diagram for explaining information transmitted from a communication module as a master to a communication module as a slave.

FIG. 11 is a sequence chart explaining wireless communication process of the wireless system according to the fourth embodiment.

### DETAILED DESCRIPTION

Hereinafter, embodiments of the technical idea will be described in detail with reference to the drawings. In the following description, the same reference numeral is designated to the same parts. The names and functions of them are the same. Therefore, the detailed description of them will not be repeated. Embodiments and modifications to be described below may be properly, selectively combined.

### First Embodiment

### System Configuration

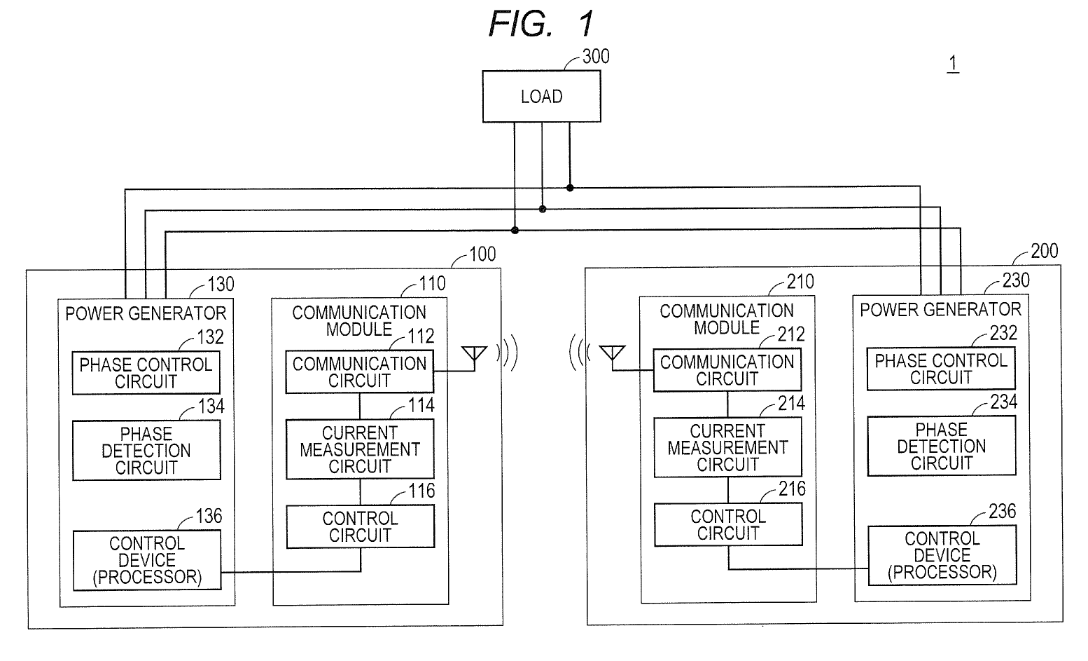

FIG. 1 is a block diagram expressing the configuration of a wireless system 1 according to a first embodiment. The wireless system 1 includes a power generating device 100, a power generating device 200, and a load 300. The power generating devices 100 and 200 are configured to supply generated power to the load 300 via a common bus.

The configuration of the power generating device 100 and that of the power generating device 200 are the same. Consequently, the configuration of the power generating device 100 will be described and description of the configuration of the power generating device 200 will not be repeated.

The power generating device 100 includes a communication module 110 and a power generator 130 (equipment). The communication module 110 includes a communication circuit 112 for performing wireless communication with (a communication circuit 212 of) the power generating device 200, a current measurement circuit 114, and a control circuit 116.

The communication circuit 112 has a transmission circuit and a reception circuit which are not illustrated. The transmission circuit includes a modulation circuit, a digital-to-analog converter, a power amplifier, and the like. The reception circuit includes a low noise amplifier, an analog-to-digital converter, a demodulation circuit, and the like. As an example, the communication circuit 112 (and the communication circuit 212) is conformed with the communication standard of Bluetooth (registered trademark) Low Energy (hereinbelow, also called “BLE”).

The current measurement circuit 114 measures consumption current as a physical quantity related to power consumed by the wireless communication process of the communication circuit 112. For example, the current measurement circuit 114 measures consumption current of the communication circuit 112 on the basis of a voltage drop amount in a resistor provided in a line of supplying power to the communication circuit 112. In another embodiment, the current measurement circuit 114 may be configured to measure consumption current of a specific device (for example, an antenna) as a component of the communication circuit 112. In further another embodiment, the communication module 110 may have a circuit capable of measuring the value of voltage applied to the communication circuit 112 in place of the current measurement circuit 114.

The control circuit 116 controls wireless operation of the communication module 110. The control circuit 116 is realized by, for example, a microcomputer. The control circuit 116 monitors a current value measured by the current measurement circuit 114 and outputs a synchronization signal to the power generator 130 on the basis of the current value. This process will be described later.

The power generator 130 has a rotor including a permanent magnet and a stator including a coil generating AC voltage at the time of rotation of the rotor. As an example, the stator has three sets of coils which are disposed at angles of 120° from one another. In this case, the power generator 130 (and the power generator 230) functions as a three-phase AC generator. In the example illustrated in FIG. 1, the power generator 130 (and the power generator 230) supplies AC power to the load 300 by three lines of three phases.

The power generator 130 further includes a phase control circuit 132, a phase detection circuit 134 and a control device 136. The phase detection circuit 134 detects the phase of the rotor of the power generator 130. As an example, the phase detection circuit 134 detects the phase of the rotor on the basis of a magnetic field detected by a hall device. In another embodiment, the phase detection circuit 134 detects the phase of an AC voltage induced by the coils of the power generator 130. The phase detection circuit 134 outputs the detected phase to the control device 136. The control device 136 outputs a control signal to the phase control circuit 132 on the basis of the difference (error) between the phase input from the phase detection circuit 134 and a target value.

The phase control circuit 132 controls the phase of the rotor of the power generator 130 in accordance with a control signal input from the control device 136. For example, the phase control circuit 132 controls the phase of the rotor by thyristor control.

### Coupling Event

Hereinbelow, as an example, in wireless communication between the communication modules 110 and 210, the communication module 110 functions as a master, and the communication module 210 functions as a slave.

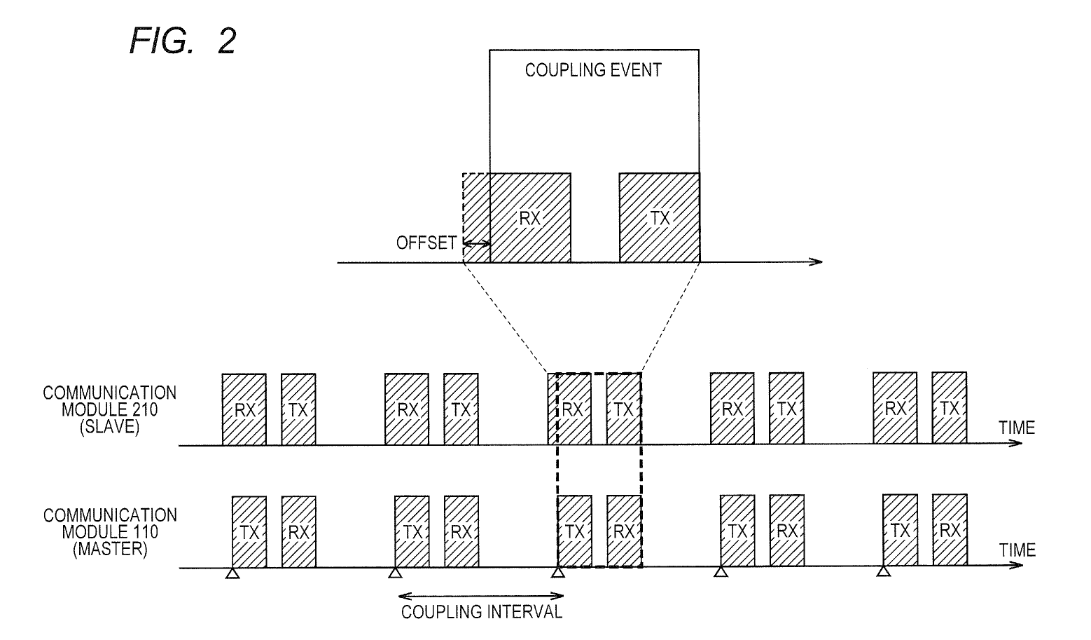

FIG. 2 is a diagram for explaining processes of the communication modules 110 and 210 in a state where coupling is established. Referring to FIG. 2, the communication modules 110 and 210 repeat a coupling event every coupling interval in a state where coupling between them is established. The coupling interval is set by the communication module 110 as a master.

When a coupling event starts, the communication module 110 as a master transmits a polling packet (corresponding to TX of the communication module 110) to the communication module 210 as a slave. On the other hand, to certainly receive the polling packet from the communication module 110, the communication module 210 shifts to a reception state (corresponding to RX of the communication module 210) before the communication module 110 only by offset time.

Each of the communication modules 110 and 210 operates according to an internal clock generated by a not-illustrated oscillation circuit. The control circuit 212 calculates offset time on the basis of cumulative total of errors of the internal clocks of the communication modules 110 and 210 and lapse time since a coupling event of the last time.

The communication module 210 transmits a response to the polling packet to the communication module 110 (corresponding to TX of the communication module 210). The communication module 110 receives the response to the polling packet from the communication module 210 (corresponding to RX of the communication module 110).

The communication modules 110 and 210 perform one of the transmitting process (TX) and the receiving process (RX) in a coupling event and, after lapse of predetermined time (for example, 150 μsec), execute the other process.

### Output Timing of Synchronization Signal

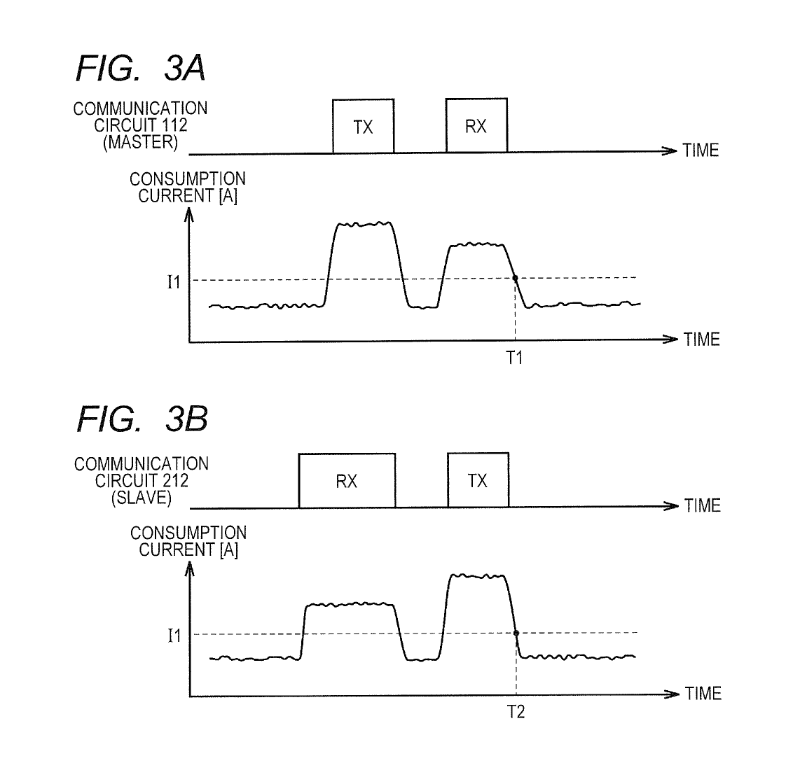

FIGS. 3A and 3B are diagrams for explaining consumption current in the communication circuits 112 and 212. FIG. 3A illustrates temporal change of consumption current of the communication circuit 112 measured by the current measurement circuit 114. FIG. 3B illustrates temporal change of consumption current of the communication circuit 212 measured by the current measurement circuit 214.

Referring to FIG. 3A, the consumption current of the communication circuit 112 becomes large in periods (operation periods) in which the transmitting process (TX) and the receiving process (RX) are performed. Referring to FIG. 3B, the consumption current of the communication circuit 212 becomes large in periods (operation periods) in which the receiving process (RX) and the transmitting process (TX) are performed.

Each of the communication modules 110 and 210 according to the first embodiment detects the end of the coupling event by using this characteristic. More concretely, the control circuit 116 as a master detects the end of the coupling event on the basis of the consumption current measured by the current measurement circuit 114 in the receiving process (RX).

In the example illustrated in FIG. 3A, the control circuit 116 detects the end of the coupling event at timing T1 when the current value measured by the current measurement circuit 114 in the receiving process (RX) falls below a predetermined threshold value I1. In another aspect, the control circuit 116 may be configured to detect the end of the coupling event at a timing when the gradient of the current value measured by the current measurement circuit 114 falls below a predetermined value in the receiving process (RX).

The control circuit 116 outputs a synchronization signal to the control device 136 in the power generator 130 at the timing T1 when the end of the coupling event is detected. In the configuration, the control circuit 116 outputs a synchronization signal to the control device 136 every almost coupling interval. The control device 136 controls the operation of the power generator on the basis of the supplied synchronization signal. As an example, the control device 136 outputs a control signal to the phase control circuit 132 so that the rotor of the power generator 130 becomes a predetermined phase (target value) at the timing of the synchronization signal which is supplied periodically from the control circuit 116.

On the other hand, the control circuit 216 of the communication module 210 as a slave detects the end of the coupling event on the basis of the consumption current measured by the current measurement circuit 214 in the transmitting process (TX). In the example illustrated in FIG. 3B, the control circuit 216 detects the end of the coupling event at timing T2 when the current value measured by the current measurement circuit 214 in the transmitting process (TX) falls below a predetermined threshold value I2. The control circuit 216 outputs a synchronization signal to a control device 236 at the timing T2 when the end of the coupling event is detected. The control device 236 outputs a control signal to a phase control circuit 232 so that the rotor of a power generator 230 becomes a predetermined phase (target value) at the timing of a synchronization signal which is periodically input from the control circuit 216. The predetermined phase (target value) is the same as the target value of the rotor of the power generator 130 described above.

With the above configuration, the wireless system 1 can make the timing T1 that the communication module 110 outputs the synchronization signal and the timing T2 that the communication module 210 outputs the synchronization signal almost aligned. The applicants of the present disclosure have confirmed that the deviation of the timings becomes 100 μsec or less. Therefore, the wireless system 1 can make a plurality of devices (the power generators 130 and 230) synchronized with high precision. Consequently, the wireless system 1 can accurately align the phase of the electromotive force induced by the power generator 130 and the phase of the electromotive force induced by the power generator 230. As a result, the wireless system 1 can supply power efficiently to the load 300. The user of the wireless system 1 does not have to couple those devices by a wire in order to synchronize the power generators 130 and 230.

### Control Structure

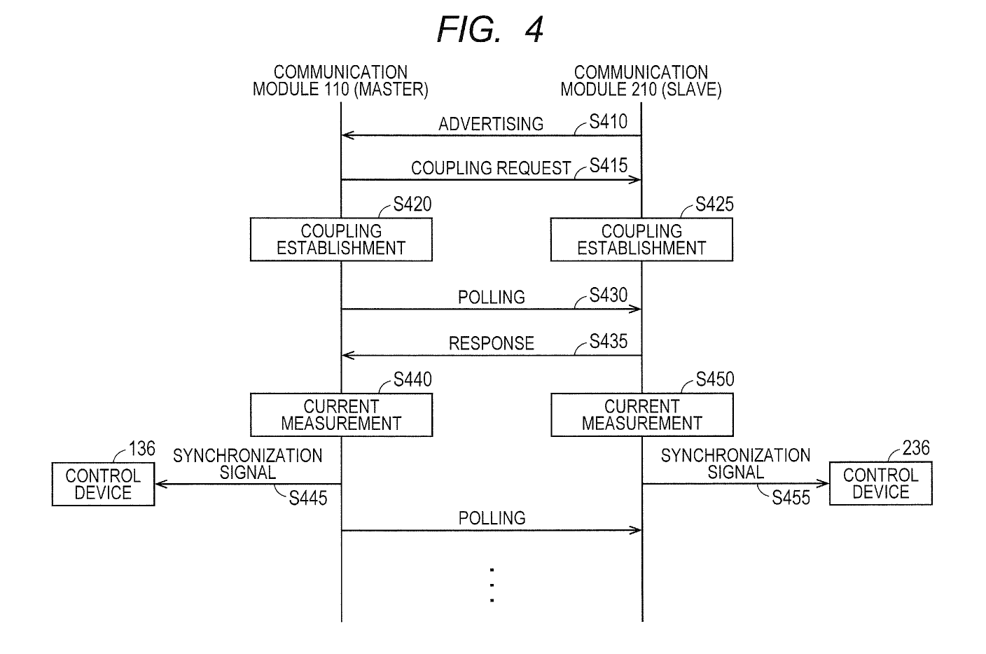

Referring to FIG. 4, the control structure of the wireless system 1 will be described. FIG. 4 is a sequence chart explaining wireless communication process of the wireless system 1 according to the first embodiment.

In step S410, the control circuit 216 (slave) periodically outputs an advertising packet in broadcast by using a predetermined channel (channels 37 to 39 of BLE).

In step 415, the control circuit 116 (master) receives the advertising packet from the communication module 210 and transmits a coupling request packet to the communication module 210 in the reception channel. The coupling request packet includes information such as the coupling interval and the master clock described in FIG. 2.

Instep S420, in response to the transmission of the coupling request packet to the communication module 210, the control circuit 116 establishes a wireless coupling to the communication module 210.

In step S425, in response to the reception of the coupling request packet from the communication module 110, the control circuit 216 establishes a wireless coupling to the communication module 110.

Instep S430, the control circuit 116 starts a coupling event and transmits a polling packet to the communication module 210.

In step S435, the control circuit 216 receives the polling packet from the communication module 110. The communication module 210 further transmits a response to the received polling packet to the communication module 110.

In step S440, the control circuit 116 monitors current (consumption current) consumed by the response receiving process (RX) in the communication circuit 112 measured by the current measurement circuit 114. In step S445, the control circuit 116 outputs a synchronization signal to the control device 136 at the timing that the monitored consumption current falls below a predetermined threshold value. The control device 136 controls the power generator 130 in accordance with the synchronization signal.

In step S450, the control circuit 216 monitors current (consumption current) consumed by the response transmitting process (TX) in the communication circuit 212 and measured by the current measurement circuit 214. In step S455, the current measurement circuit 214 outputs a synchronization signal to the control device 236 at the timing that the monitored consumption current falls below the predetermined threshold. The control device 236 controls the power generator 230 in accordance with a synchronization signal. After that, the processes in steps S430 to S455 are repeated every coupling interval.

By the above, each of the communication modules 110 and 210 can detect the end of the coupling event on the basis of the current value. Consequently, the communication modules 110 and 210 can detect the end of the coupling event without being influenced by delay time accompanying A/D (analog-to-digital) conversion and D/A (digital-to-analog) conversion. As a result, the wireless system 1 can synchronize the plurality of devices (the power generators 130 and 230) with high precision.

### Second Embodiment

The wireless system 1 according to the first embodiment is configured to perform synchronizing process based on a synchronization signal every coupling event. However, depending on the characteristics of a device to be synchronized (for example, the power generators 130 and 230), once the synchronizing process is performed, a synchronization state is maintained for a while. In such a case, the wireless system does not have to perform the synchronizing process frequently. Consequently, a wireless system according to a second embodiment is configured to perform synchronizing process based on a synchronization signal every predetermined number of times of coupling events. The configuration of the wireless system according to the second embodiment is the same as that of the wireless system. 1 illustrated in FIG. 1. Consequently, the description of the configuration of the wireless system according to the second embodiment will not be repeated.

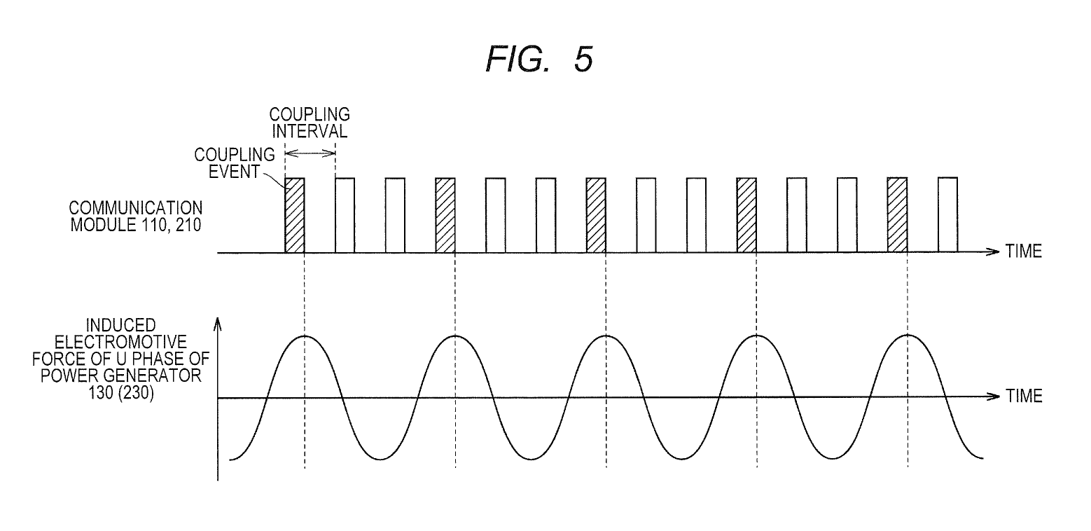

FIG. 5 is a diagram for explaining a timing of outputting a synchronization signal by the wireless system 1 according to the second embodiment. In the example illustrated in FIG. 5, the control circuits 116 and 216 according to the second embodiment are configured to output a synchronization signal once every three coupling events (a synchronization signal is output at hatched coupling events).

With the configuration, the wireless system 1 according to the second embodiment does not execute a synchronizing process within a range in which a deviation of the operations (phases) of a plurality of devices (the power generators 130 and 230) can be permitted. Consequently, the wireless system 1 can reduce the load of the synchronizing process.

The control circuit 116 as a master sets a coupling interval so that the coupling intervals of three times (that is, the output intervals of the synchronization signals) correspond to a predetermined operation cycle (for example, 50 Hz or 60 Hz) of the power generator 130 (power generator 230).

In the example of FIG. 5, the phase detection circuit 134 detects the induced electromotive force of a coil corresponding to the U phase provided for the stator of the power generator 130. The control device 136 outputs a control signal to the phase control circuit 132 so that the induced electromotive force detected by the phase detection circuit 134 becomes a peak at a timing when the synchronization signal is supplied from the control circuit 116.

With the configuration, since the output interval of the synchronization signals and the operation cycle of the power generator 130 are the same, the control device 136 can execute the synchronizing process of the power generator 130 by simple control. The power generating device 200 also executes the above-described process.

In the above-described example, the wireless system 1 is configured to output a synchronization signal every operation cycle of the power generator. In another aspect, it may be configured to output a synchronization signal at integral multiple of operation cycles of the power generator. In this case as well, the wireless system 1 can realize the synchronizing process by simple control.

In an aspect, the control circuit 116 as a master transmits a polling packet of fixed length to the communication module 210, and the control circuit 216 as a slave transmits a response of fixed length to the communication module 110. In the case where the size of the polling packet or response is variable, the length of (the transmitting process (TX)/receiving process (RX) as a component of) a coupling event becomes variable. Consequently, in the wireless system 1 according to the second embodiment, by setting the polling packet and the response to fixed length, the length of the coupling event is fixed. Therefore, only by setting the coupling interval so as to correspond to the predetermined operation cycle of the power generator, the wireless system 1 can easily output a synchronization signal every operation cycle of the power generator.

### Third Embodiment

The wireless system 1 according to the foregoing embodiments is configured to execute the synchronizing process for a period in which the power generator operates. On the other hand, a wireless system according to a third embodiment is configured to switch a synchronization mode of executing the synchronizing process and a normal mode of transmitting/receiving messages between communication modules in a time division manner. The configuration of the wireless system according to the third embodiment is the same as that of the wireless system 1 illustrated in FIG. 1. Consequently, description of the configuration of the wireless system according to the third embodiment will not be repeated.

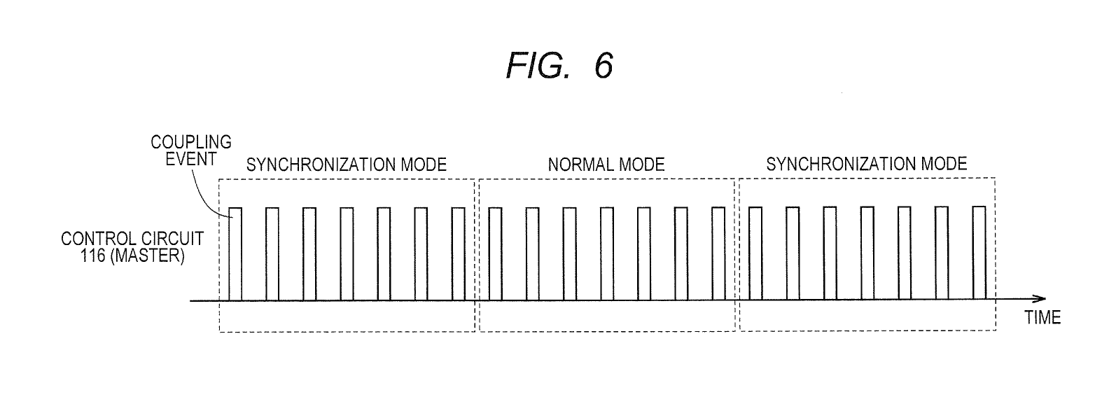

FIG. 6 is a diagram for explaining the synchronization mode and the normal mode of the wireless system 1 according to the third embodiment. In the example illustrated in FIG. 6, the control circuit 116 as a master is configured to switch the synchronization mode and the normal mode every seven times of coupling events. The period of the synchronization mode (the number of times of coupling events) and the period of the normal mode may be different from each other. For example, the control circuit 116 may be configured so as to switch the synchronization mode and the normal mode on the basis of a pattern stored in a not-illustrated memory. In place of the control circuit 116, the control device 136 may be configured to execute the process of switching the synchronization mode and the normal mode.

The control circuits 116 and 216 execute the synchronizing process based on the above-described consumption current value in the synchronization mode and output a synchronization signal to the power generator. On the other hand, the control circuits 116 and 216 do not execute the synchronizing process in the normal mode. That is, the control circuits 116 and 216 do not output a synchronization signal in the normal mode.

The communication module 110 as a master transmits some information to the communication module 210 as a slave in the normal mode. As an example, the user enters a setting change to the power generating device 100 on the master side (for example, the frequency of the AC power to be output is changed from 50 Hz to 60 Hz). In the normal mode, the control device 136 on the master side generates a packet for normal including information expressing the setting change in a payload and transmits the generated packet to the communication module 210.

The control device 236 on the slave side changes the setting of the power generating device 200 on the basis of the information expressing the setting change included in the received packet for normal. With the configuration, the user does not have to enter the setting change to each of the plurality of devices configuring the wireless system 1.

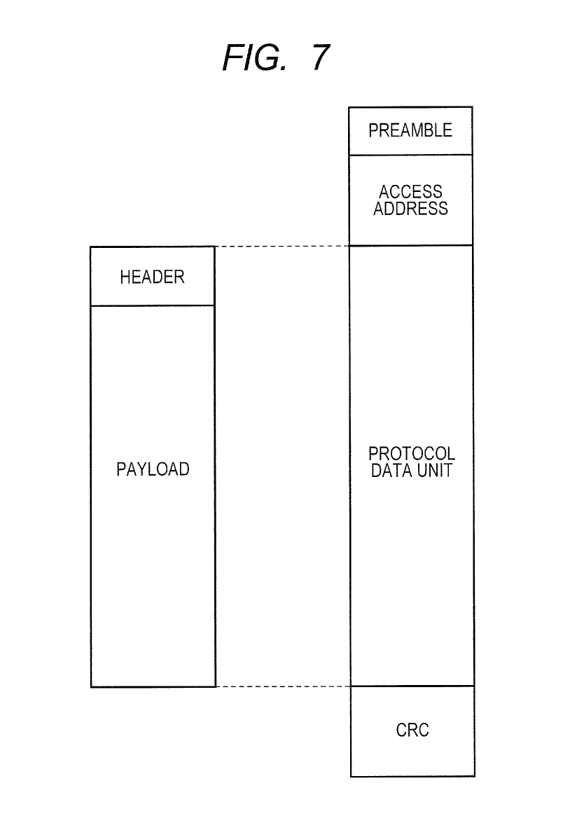

Next, referring to FIG. 7, the data structure of a packet (hereinbelow, also called “packet for synchronization”) transmitted/received in a coupling event in the synchronization mode and that of a packet (hereinbelow, also called “packet for normal”) transmitted/received in a coupling event in the normal mode will be described.

### Data Structure

FIG. 7 is a diagram expressing an example of the data structure of a packet transmitted/received between the communication modules 110 and 210. Referring to FIG. 7, a packet conformed with the communication standard of BLE includes a preamble of one byte, an access address of four bytes, a protocol data unit (PDU) of two bytes or more, and a CRC (Cyclic Redundancy Checksum) of three bytes. The protocol data unit has a header of two bytes and a payload.

The size of the payload of the packet for synchronization is fixed. As an example, the packet for synchronization does not have a payload (that is, the payload has zero byte). On the other hand, the packet for normal has a payload of a various size of one byte or more.

The communication module 110 as a master executes the process of switching the synchronization mode and the normal mode by itself and, therefore, can determine the present communication mode. Consequently, the communication module 110 executes the above-described synchronizing process in the case where the communication is performed in the synchronization mode.

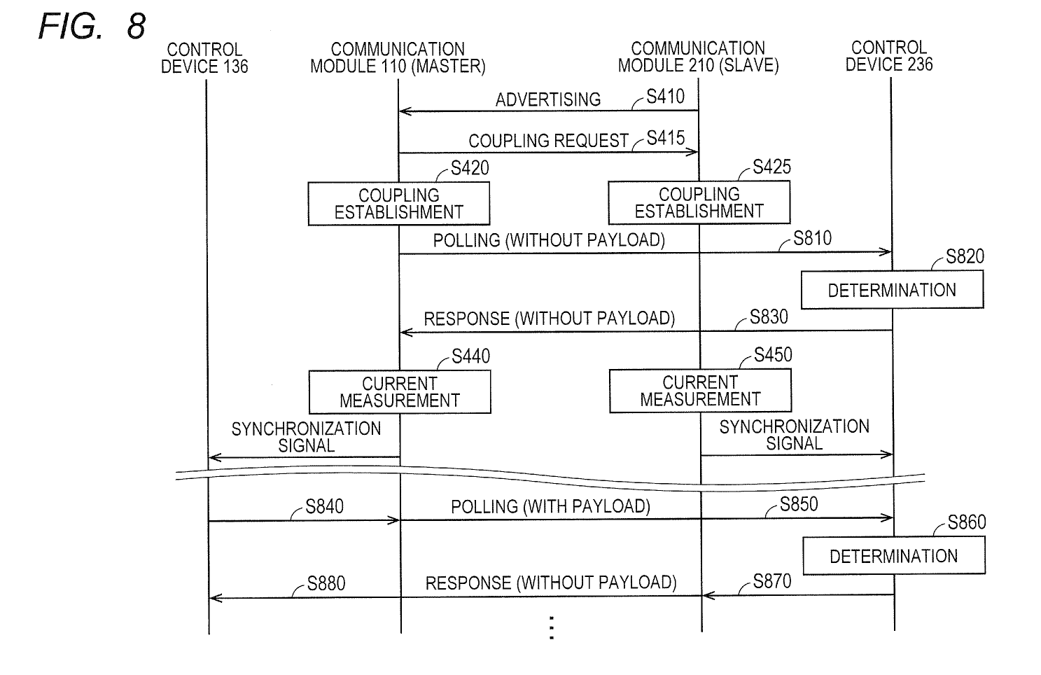

On the other hand, the communication module 210 as a slave determines which packet is received by using the difference between the size of the packet for synchronization and the size of the packet for normal. When the packet for synchronization is received, the communication module 210 executes the synchronizing process. The process will be described with reference to FIG. 8.

### Control Structure

FIG. 8 is a sequence chart explaining wireless communication process of the wireless system. 1 according to the third embodiment. The same reference numerals are designated to the same process as the above-described process in the processes illustrated in FIG. 8. Consequently, the description of the same processes will not be repeated.

In step S810, the control circuit 116 in the communication module 110 transmits a polling packet (packet for synchronization) which does not include a payload to the communication module 210. The communication module 210 converts the received packet to a digital signal and outputs the digital signal to the control device 236.

In step S820, the control device 236 determines that the packet is the packet for synchronization on the basis of the fact that the received packet does not include a payload.

In step S830, the control device 236 generates a response which does not include a payload (the packet for synchronization) and transmits the generated response to the communication module 110 via the communication module 210.

In step S440, the control circuit 116 grasps that the transmitting/receiving processes in S810 and S830 are the coupling event in the synchronization mode. Consequently, the control circuit 116 monitors current (consumption current) consumed by the response receiving process (RX) in the communication circuit 112 measured by the current measurement circuit 114. In step S445, the control circuit 116 outputs a synchronization signal to the control device 136 at the timing that the consumption current monitored falls below a predetermined threshold value. The control device 136 controls the power generator 130 in accordance with the synchronization signal.

In step S450, the control circuit 216 monitors the current consumed by the response transmitting process (TX) in the communication circuit 212 measured by the current measurement circuit 214 on the basis of the determination that the packet is the packet for synchronization (synchronization mode) in step S815. In step S455, the current measurement circuit 214 outputs a synchronization signal to the control device 236 at the timing that the consumption current being monitored falls below the predetermined threshold value. The control device 236 controls the power generator 230 in accordance with the synchronization signal. After that, the processes in steps S810 to S455 are repeated by the predetermined number of times.

In step S840, the control device 136 generates a packet for normal including a payload and outputs it to the communication module 110. In step S850, the control circuit 116 converts the packet for normal to an analog signal and transmits the analog signal to the communication module 210. The communication module 210 converts the received analog signal (packet for normal) to a digital signal and outputs the digital signal to the control device 236.

In step S860, the control device 136 determines that the packet is a packet for normal on the basis the fact that the received packet includes a payload. In step S870, the control device 236 generates a response which does not include a payload and outputs it to the communication module 210. In step S880, the communication module 210 converts the input response to an analog signal and transmits the analog signal to the communication module 110. The communication module 110 converts the received analog signal to a digital signal and outputs the digital signal to the control device 136.

The control circuit 116 grasps that the transmitting/receiving processes in S850 and S880 are coupling events in the normal mode. Consequently, the control circuit 116 does not execute synchronizing process for outputting a synchronization signal. Based on the determination that the packet is the packet for normal (normal mode) in step S960, the control circuit 216 does not execute the synchronizing process for outputting the synchronization signal.

By the above, the wireless system 1 according to the third embodiment can perform communication while switching the synchronization mode and the normal mode by using the difference between the size of the packet for synchronization and the size of the packet for normal.

In another aspect, it maybe configured that the communication module 210 as a slave has the same pattern as the pattern of switching the synchronization mode and the normal mode (for example, switching every predetermined cycle) of the communication module 110 as a master. In such a case, the communication module 210 as a slave can make the determination of the synchronization mode/normal mode according to the pattern in place of the determination of the synchronization mode/normal mode based on the packet sizes.

### Fourth Embodiment

In the foregoing embodiment, each of the master and the slave controls the operation of the power generator at the timing that the end of the coupling event is detected. That is, the master and the slave do not substantially have a master-slave relation. On the other hand, in a wireless system according to the fourth embodiment, the slave synchronizes with the master on the basis of information received from the master.

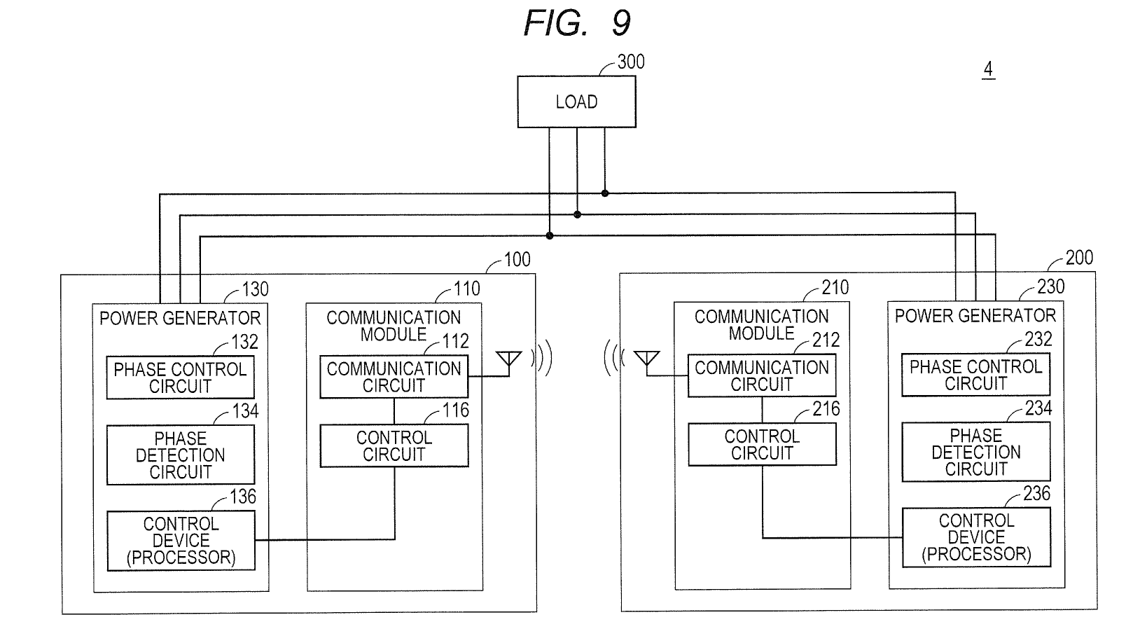

FIG. 9 is a block diagram expressing the configuration of a wireless system 4 according to the fourth embodiment. The wireless system 4 is different from the wireless system 1 described in FIG. 1 with respect to the point that the current measurement circuits 114 and 214 are not provided.

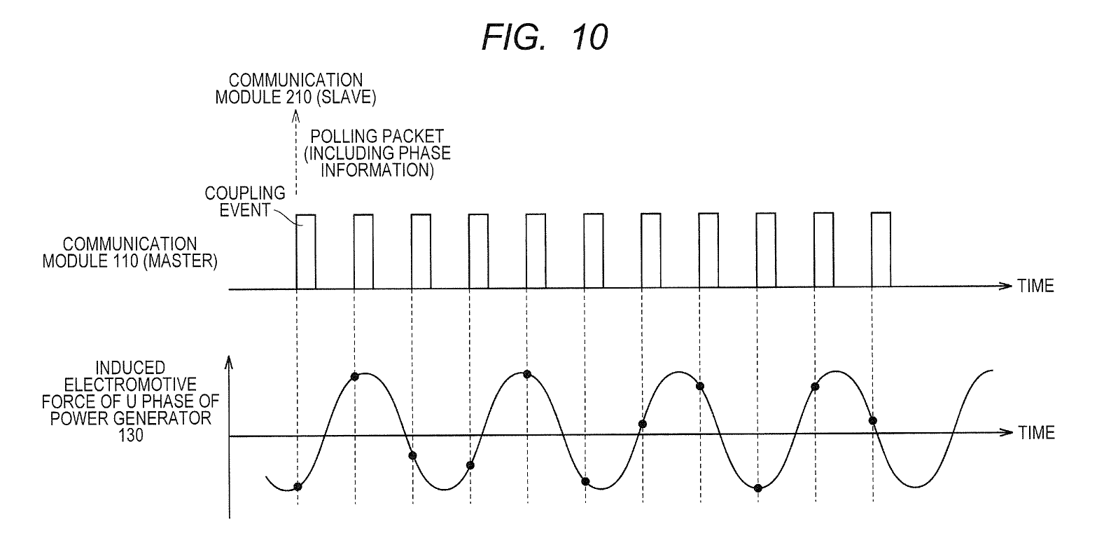

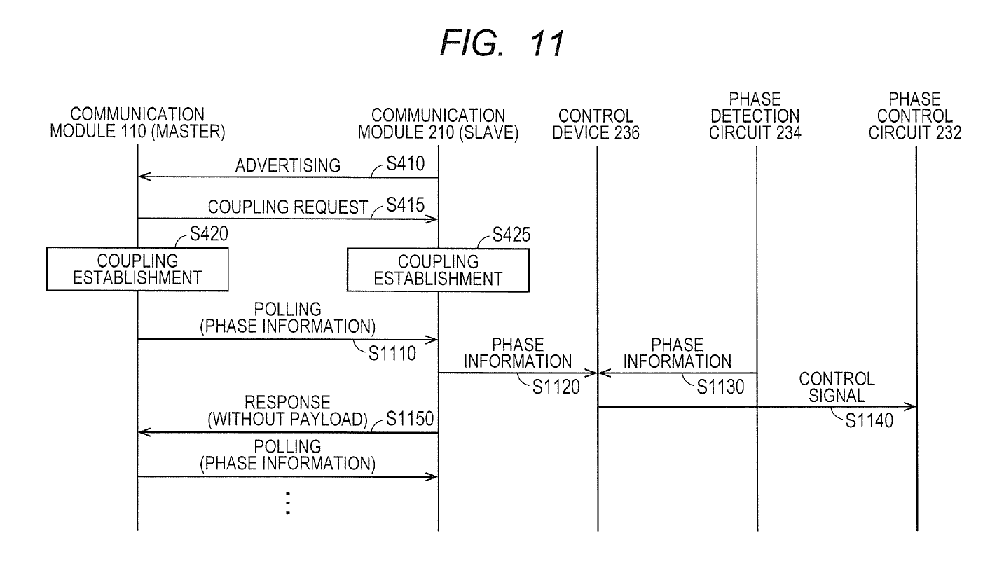

FIG. 10 is a diagram for explaining information transmitted from the communication module 110 as a master to the communication module 210 as a slave. FIG. 11 is a sequence chart explaining wireless communication process of the wireless system 4 according to the fourth embodiment. Hereinafter, referring to FIGS. 10 and 11, the synchronizing process of the wireless system 4 will be described. The same reference numerals are designated to processes which are the same as those described above, in the processes illustrated in FIG. 11. The description of the same processes will not be repeated.

In the example illustrated in FIG. 10, the phase detection circuit 134 detects the phase of induced electromotive force of the coil corresponding to the U phase provided for the stator of the power generator 130. For example, the phase detection circuit 134 detects the phase by multiplying the induced electromotive force of the coil corresponding to the U phase by an inverse trigonometric function. In another example, the phase detection circuit 134 may be configured to detect the phase of the rotor of the power generator 130. The phase detected by the phase detection circuit 134 can be also said as the phase corresponding to the operation cycle of the power generator 130.

The control device 136 generates a packet for synchronization (polling packet) in which the phase detected by the phase detection circuit 134 is included in the payload every coupling interval (for example, 7.5 msec) and outputs it to the communication module 110 (step S1110). In another aspect, the phase detection circuit 134 may detect the phase of each of the U, V, and W phases, and the control device 136 may generate a packet for synchronization in which the U, V, and W phases are included in a payload. The communication module 110 converts the input packet for synchronization into a digital signal and transmits the digital signal to the communication module 210.

The communication module 210 converts the received packet for synchronization to a digital signal and outputs the digital signal to the control device 236 (step S1120). The phase detection circuit 234 detects the phase for the operation cycle of the power generator 230 and outputs the detection result to the control device 236 (step S1130).

The control device 236 outputs a control signal based on the difference between the phase input from the phase detection circuit 234 and the phase included in the received packet for synchronization to the phase control circuit 232 (step S1140). Consequently, the phase for the operation cycle of the power generator 230 is synchronized with the phase for the operation cycle of the power generator 130. The control device 216 transmits a response to a polling packet to the communication module 110 (step S1150). Hereinafter, the wireless system 1 repeats the processes in steps S1110 to S1150.

By the above, by transmitting/receiving a packet including the phase information, the wireless system 4 according to the fourth embodiment can obtain synchronization without including a current measurement circuit.

### Other Configurations

Although the communication modules 110 and 210 are configured to output a synchronization signal to synchronize the power generators 130 and 230 in the foregoing embodiments, the devices to obtain synchronization are not limited to power generators. For example, the communication modules 110 and 210 may be configured to output a synchronization signal to synchronize a plurality of motors.

Although one slave is coupled to the master (communication module 110) in the foregoing embodiments, two or more slaves may be coupled to a master in another embodiment.

In the above description, the process is executed by any of the control circuits 116 and 216 and the control devices 136 and 236. Each of the devices is configured by at least one semiconductor integrated circuit such as a processor, at least one ASIC (Application Specific Integrated Circuit) for a specific use, at least one DSP (Digital Signal Processor), at least one FPGA (Field Programmable Gate Array), and/or a circuit having another arithmetic function.

The control devices can execute the above-described various processes by reading one or more commands from at least one readable tangible medium.

Such a medium has a form such as a magnetic medium (for example, hard disk), an optical medium (for example, a compact disk (CD) or DVD), or a memory of an arbitrary type of a volatile memory or a nonvolatile memory but is not limited to those forms.

The volatile memory can include a DRAM (Dynamic Random Access Memory) and an SRAM (Static Random Access Memory). The nonvolatile memory can include a ROM and an NVRAM.

### Configuration

The technical features disclosed above can be summarized as follows.

### Configuration 1

The wireless system 1 has the power generators 100 and 200 for synchronization operation. The power generator 100 includes: the communication circuit 112 for performing wireless communication with the power generator 200; the current measurement circuit 114 for measuring a physical quantity (for example, current amount) related to power consumed by wireless communication process of the communication circuit 112; the control circuit 116 outputting a first synchronization signal at a timing that the magnitude relation between the physical quantity measured by the current measurement circuit 114 with respect to one of transmitting process and receiving process in the wireless communication process and a predetermined threshold changes (the timing that the physical quantity falls below the threshold value or the timing that the physical quantity goes above the threshold value); and the power generator 130 operating according to a first synchronization signal output by the control circuit 116. The power generator 200 includes: the communication circuit 212 for performing wireless communication with the power generator 100; the current measurement circuit 214 for measuring a physical quantity related to power consumed by wireless communication process of the communication circuit 212; a second control circuit outputting a second synchronization signal at a timing that the magnitude relation between the physical quantity measured by the current measurement circuit 214 with respect to the other one of the transmitting process and the receiving process in the wireless communication processes in the communication circuit 212 and the predetermined threshold value changes; and the power generator 230 operating according to a second synchronization signal output by the second control circuit.

### Configuration 2

The communication module 110 has: the communication circuit 112 for performing wireless communication with the power generating device 200; the current measurement circuit 114 for measuring a physical quantity related to power consumed by wireless communication process of the communication circuit 112; and the control circuit 116 outputting a synchronization signal for synchronizing the power generator 130 and (the power generator 230) of the power generating device 200. The control circuit 116 is configured to output a synchronization signal to the power generator 130 at a timing that the magnitude relation between the physical quantity measured by the current measurement circuit 114 with respect to one of receiving process and transmitting process in the wireless communication process and a predetermined threshold value changes.

### Configuration 3

In the configuration 2, the communication module 110 functions as a slave, and the power generating device 200 functions as a master. In this case, the communication circuit 112 receives a polling packet from the power generating device 200 and transmits a response to the power generating device 200. The control circuit 116 is configured to output a synchronization signal to the power generator 130 at a timing that the magnitude relation between the physical quantity measured by the current measurement circuit 114 and consumed by the response transmitting process and a predetermined threshold value changes.

### Configuration 4

In the configuration 2, the communication module 110 functions as a master, and the power generating device 200 functions as a slave. In this case, the communication circuit 112 transmits a polling packet to the power generating device 200 and receives a response to the polling packet from the power generating device 200. The control circuit 116 is configured to output a synchronization signal to the power generating device 130 at a timing that the magnitude relation between the physical quantity related to power measured by the current measurement circuit 114 and consumed by the response receiving process and a predetermined threshold value changes.

### Configuration 5

The size of a packet transmitted/received between the communication circuit 112 and the power generating device 200 is fixed length.

### Configuration 6

The power generator 130 and the power generating device 200 are configured to operate in predetermined cycles. The control circuit 116 is configured to output the synchronization signal to the power generator 130 at integral multiple of the predetermined cycle.

### Configuration 7

The control circuit 116 is configured to operate in a first mode of outputting the synchronization signal to the power generator 130 and, after that, in a second mode of outputting no synchronization signal to the power generator 130.

### Configuration 8

In the configuration 7, the control circuit 116 is configured to switch the first and second modes in accordance with a predetermined pattern (for example, every cycle).

### Configuration 9

The wireless system 4 has the power generating devices 100 and 200. The power generating device 100 includes: the power generator 130 which operates in predetermined cycles; the phase detection circuit 134 for detecting the phase of the power generator 130 in the predetermined cycle (for example, the rotation phase of the rotor of the power generator 130, the phase of AC voltage induced by the coil of the power generator 130); and the communication circuit 112 for wirelessly transmitting a packet (polling packet) including the phase detected by the phase detection circuit 134 to the power generating device 200. The power generating device 200 includes: the power generator 230 which operates in the predetermined cycles; the phase detection circuit 234 for detecting the phase of the power generator 230 in the predetermined cycle; the communication circuit 212 for receiving the packet including the phase from the power generating device 100; and the control device 236 synchronizing the phase of the power generator 230 with the phase of the power generator 130 on the basis of the phase detected by the phase detection circuit 234 and the phase included in the received packet.

Although the present invention achieved by the inventors herein has been concretely described above on the basis of the embodiments, obviously, the invention is not limited to the foregoing embodiments and can be variously changed without departing from the gist. The embodiments and modifications can be properly combined.

What is claimed is:

1. A wireless synchronization system comprising a first device and a second device,
wherein the first device includes:
a first communication circuit for performing wireless communication with the second device;
a first sensor for measuring a physical quantity related to power consumed by wireless communication process of the first communication circuit;
a first control circuit outputting a first synchronization signal at a timing that the magnitude relation between the physical quantity measured by the first sensor with respect to one of transmitting process and receiving process in the wireless communication process and a predetermined threshold value changes; and
a first equipment operating according to a first synchronization signal output by the first control circuit, and
wherein the second device includes:
a second communication circuit for performing wireless communication with the first device;
a second sensor for measuring a physical quantity related to power consumed by wireless communication process of the second communication circuit;
a second control circuit outputting a second synchronization signal at a timing that the magnitude relation between the physical quantity measured by the second sensor with respect to the other one of the transmitting process and the receiving process in the wireless communication process in the second communication circuit and a predetermined threshold value changes; and
a second equipment operating according to the second synchronization signal output by the second control circuit.

2. A wireless device comprising:
a communication circuit for performing wireless communication with an external device;
a sensor for measuring a physical quantity related to power consumed by wireless communication process of the communication circuit; and
a control circuit outputting a synchronization signal for synchronizing an equipment and the external device to the equipment,
wherein the control circuit is configured to output a synchronization signal to the equipment at a timing that the magnitude relation between the physical quantity measured by the sensor with respect to one of receiving process and transmitting process in the wireless communication process and a predetermined threshold value changes.

3. The wireless device according to claim 2,
wherein the communication circuit receives a polling packet from the external device and transmits a response to the external device, and
wherein the control circuit is configured to output a synchronization signal to the equipment at a timing that the magnitude relation between the physical quantity related to power consumed by process of transmitting the response and measured by the sensor and a predetermined threshold value changes.

4. The wireless device according to claim 2,
wherein the communication circuit transmits a polling packet to the external device and receives a response to the polling packet from the external device, and
wherein the control circuit is configured to output a synchronization signal to the equipment at a timing that the magnitude relation between the physical quantity related to power consumed by process of receiving the response and measured by the sensor and a predetermined threshold value changes.

5. The wireless device according to claim 2, wherein the size of a packet transmitted/received between the communication circuit and the external device is fixed length.

6. The wireless device according to claim 2,
wherein the equipment and the external device are configured to operate in predetermined cycles, and
wherein the control circuit is configured to output the synchronization signal to the equipment at integral multiple of the predetermined cycle.

7. The wireless device according to claim 2, wherein the control circuit is configured to operate in a first mode of outputting the synchronization signal to the equipment and, after that, in a second mode of outputting no synchronization signal to the equipment.

8. The wireless device according to claim 7, wherein the control circuit is configured to switch the first and second modes in accordance with a predetermined pattern.

9. A wireless synchronization system comprising a first device and a second device,
wherein the first device includes:
a first equipment which operates in a predetermined cycle;
a first sensor for detecting the phase of the first equipment in the predetermined cycle; and
a first communication circuit for wirelessly transmitting a packet including the phase detected by the first sensor to the second device, and
wherein the second device includes:
a second equipment which operates in the predetermined cycle;
a second sensor for detecting the phase of the second equipment in the predetermined cycle;
a second communication circuit for receiving the packet from the first device; and
a control device synchronizing the phase of the second equipment with the phase of the first equipment on the basis of the phase detected by the second sensor and the phase included in the received packet.
